(19) United States
(12) Patent Application Publication
(10) Pub. No.: US 2026/0249437 A1
(43) Pub. Date: Aug. 27, 2026

(54) SHOCK ABSORBING DEVICE FOR A RECHARGEABLE BATTERY

(71) Applicant: Hilti Aktiengesellschaft, Schaan (LI)

(72) Inventors: Thomas BADER, Landsberg am Lech (DE); Karin GROTH, Herrsching (DE); Timo SEEL, Wiedergeltingen (DE); Manuel ROSENZWEIG, Kaufering (DE); Juan ZHU, Kaufering (DE); Torsten TUSSING, Obermeitingen (DE); Mark DULING, Hiltenfingen (DE)

(21) Appl. No.: 18/995,558

(22) PCT Filed: Jul. 25, 2023
(86) PCT No.: PCT/EP2023/070571

§ 371 Date: Jan. 16, 2025

(30) Foreign Application Priority Data
Aug. 8, 2022 (EP) 22189232.6

(51) Int. Cl. B25D 17/04; H01M 50/242; H01M 50/247

(52) U.S. Cl. CPC B25D 17/043; H01M 50/242; H01M 50/247; B25D 2222/57; B25D 2250/091; B25D 2250/121; B25D 2250/245

(57) ABSTRACT

A machine tool, in particular a chipping hammer, having a housing, a working axis running in a longitudinal direction, at least one rechargeable battery interface device for detachably connecting at least one rechargeable battery to the machine tool, and a first side handle with a first primary direction of extension and a second side handle with a second primary direction of extension. The side handles are arranged substantially symmetrically about the working axis. At least one decoupling device is provided to create a vibration-damping connection of the side handles to the housing. A protective device for protecting a rechargeable battery coupled to the battery interface device is provided. The protective device has an interior space for at least partially accommodating at least one rechargeable battery. The protective device encloses the circumference of the housing with respect to the longitudinal direction, and is connected to at least one side handle via at least one connecting device.

The present invention relates to a machine tool, in particular to a chipping hammer.

### BACKGROUND

A chipping hammer with a housing is known from EP 3 943 251 A1, wherein a drive device of the chipping hammer can be supplied with energy by rechargeable batteries. Two laterally arranged handles are provided, wherein a decoupling device is provided for reducing vibrations acting on the handles during operation. The chipping hammer has provisions for the arrangement of two rechargeable batteries, which can be arranged on a side of the housing facing away from a tool holder, and thus above the housing, by means of a battery interface device on the housing. A protective device is provided for protecting the rechargeable batteries.

### SUMMARY OF THE INVENTION

Disadvantageously, such a chipping hammer has a large constructed height in the longitudinal direction of the chipping hammer. In the event that the chipping hammer falls over or is dropped, the potentially long fall can apply high forces to the rechargeable batteries, such that a protective device therefor must be particularly stable and solid.

Furthermore, an impact hammer with a housing is known from DE 10 2018 210 189 A1, wherein a center of gravity of the machine tool is arranged substantially on the working axis. The machine tool has a battery interface via which a rechargeable battery pack can be detachably connected to the machine tool. The handles are each connected to the housing via a damping unit. It is further disclosed that the battery pack is arranged below a handle, and is protected by a protective element connected to the handle.

Disadvantageously, the protection of the battery pack in the case of such a design may be insufficient or undesirably minimal, in particular in the event that the machine tool is dropped or receives an impact.

It is an object of the present invention to provide a machine tool, in particular a chipping hammer, wherein a constructed height of the machine tool is reduced, and wherein the rechargeable batteries connected to the machine tool can be reliably protected with a simple construction.

A machine tool, in particular a chipping hammer, is provided with a housing, a working axis running in a longitudinal direction, at least one battery interface device for detachably connecting at least one rechargeable battery to the machine tool, and a first side handle with a first primary direction of extension and a second side handle with a second primary direction of extension, wherein the side handles are arranged substantially symmetrically with respect to the longitudinal direction, wherein at least one decoupling device is provided to create a vibration-damping connection of the side handles to the housing, wherein a protective device is provided for protecting a rechargeable battery coupled to the battery interface device, and wherein the protective device has an internal volume for at least partially accommodating the at least one rechargeable battery.

According to the invention, the protective device encloses the circumference of the housing with respect to the longitudinal direction, and is connected to at least one side handle via at least one connecting device.

A machine tool designed according to the invention has the advantage that rechargeable batteries connected to the at least one rechargeable battery interface device can be protected against damage in a simple manner, in particular in all operating states of the machine tool. This is achieved by the design of the protective device comprising the housing, as a result of which a support of the protective device on the housing is achieved in a simple manner. Furthermore, rechargeable batteries connected to the battery interface device are protected against vibrations by the fact that the battery interface device is coupled to the side handles, which are decoupled from the housing during operation by means of the decoupling device.

Furthermore, a machine tool designed according to the invention has an advantageously low constructed height in the longitudinal direction of the machine tool. This is achieved because the protective device comprises the housing and is therefore not arranged on a side of the housing facing away from a tool holder. Furthermore, because of an arrangement of the battery interface device in an end region of the machine tool facing away from a tool holder, a center of gravity of the machine tool is advantageously arranged close to a work surface. As a result, a maximum drop height of a rechargeable battery connected to the battery interface device in operation of the machine tool, because of an arrangement of the rechargeable battery in an end region of the machine tool facing away from the tool holder, is also reduced, such that the risk of damage to a rechargeable battery connected to the battery interface device is reduced.

The first side handle and the second side handle define in each case a first primary direction of extension or a second primary direction of extension, wherein the primary directions of extension, in an non-loaded state of the side handles, are arranged in particular substantially perpendicular to the longitudinal direction, and extend substantially in a transverse direction. A center of gravity of the machine tool in an upright position preferably lies substantially on a working axis of the machine tool defined by the tool holder.

Because of the decoupling device, mechanical influences acting during operation of the machine tool, such as, for example, impacts, shocks or the like, are reduced for a user holding the machine tool by the side handles. Furthermore, a rechargeable battery connected to the battery interface device is also protected by the decoupling device from mechanical influences, and/or the effects thereof on a rechargeable battery connected to the battery interface device are greatly reduced.

In an advantageous embodiment of a machine tool according to the invention, the connecting device enables a movement of the protective device substantially in the longitudinal direction relative to the housing. As a result, decoupling of the protective device and thus also of the battery interface device from the housing is achieved in a simple manner. Moreover, the housing may function as a guide for the protective device, and contribute to the stability of the protective device.

In a structurally simple embodiment of the invention, the connecting device has at least two levers, wherein the protective device is connected to the first side handle by means of a first lever and to the second side handle by means of a second lever. The protective device is coupled to the side handles by means of the levers, and is protected by the decoupling device, in a manner corresponding to that of the side handles, from vibrations acting on the housing during operation of the machine tool.

A particularly good protection of rechargeable batteries connected to the battery interface device can be achieved if the connecting device has at least two flexible elements, wherein the protective device is connected to the first side handle by means of a first flexible element, and to the second side handle by means of a second flexible element. As a result of the flexible elements, vibrations acting on the protective device and thus also on the rechargeable batteries can be further damped during operation of the machine tool. Furthermore, additional protection is also ensured in the event that the machine tool is dropped or falls.

In a preferred embodiment of a machine tool according to the invention, the flexible elements are designed with an elastomeric material. In principle, however, any materials with resilient or damping properties can be used.

In order to limit the freedom of movement of the protective device relative to the housing in the longitudinal direction, and thereby to achieve good drop protection, the protective device can have a first stop region and the housing can have a second stop region, wherein the protective device and the housing come into contact with one another via the stop regions when the protective device is displaced by a defined threshold value in the longitudinal direction relative to the housing, starting from a rest position.

Alternatively or additionally, it can be provided that the protective device has a third stop region and the housing has a fourth stop region, the third stop region and the fourth stop extending substantially in the longitudinal direction. On the one hand, a guide of the protective device relative to the housing is provided during the damping of vibrations by the interaction of the third stop region with the fourth stop region, which are preferably circumferential in design. On the other hand, this interaction achieves a support of the protective device on the housing, for example in the event that the machine tool is dropped or falls. In the idle state of the machine tool, there is a distance between the third stop region and the fourth stop region, in particular circumferentially, which distance is selected such that a jamming of the protective device relative to the housing during operation of the machine tool is reliably prevented.

An embodiment of the invention that is improved with respect to a center of gravity, the view of a user in the direction of a working region, and a constructed length of the machine tool is achieved if the protective device and thus also the rechargeable battery interface device, and a rechargeable battery which is optionally connected to the battery interface device, are arranged on a side of each side handle facing a tool holder with respect to the longitudinal direction, and in particular below the side handles in the longitudinal direction.

In an advantageous embodiment of a machine tool according to the invention, the protective device has at least two rechargeable battery interface devices, wherein the rechargeable battery interface devices are arranged in particular substantially symmetrically with respect to the longitudinal axis. It can also be provided that the protective device has three, four or more battery interface devices. At least one rechargeable battery can be connected to a battery interface device. It can also be provided that two, three or more rechargeable batteries can be operatively connected to a battery interface device.

In order to enable an arrangement of a rechargeable battery in an insertion direction on the respective battery interface device in a simple manner, at least one protective device can have a recess, which faces substantially perpendicular to the longitudinal direction and perpendicular to a transverse direction, for the operative connection of a rechargeable battery to the battery interface device. In principle, it can also be provided that the protective device is designed such that an arrangement of a rechargeable battery on the given battery interface device is made possible in an insertion direction oriented as desired.

In an advantageous embodiment of a machine tool according to the invention, at least one protective device is configured in such a way that, with the rechargeable battery connected to the battery interface device, and in the event that the machine tool is dropped in any direction, the at least one protective device comes into contact with a flat ground surface before the rechargeable battery connected to the battery interface device. In this way, a particularly good protection of a rechargeable battery connected to a battery interface device in any operating situation can be ensured.

In an advantageous embodiment of the invention, a first decoupling device, which has a first spring device and a first lever device, by means of which the first side handle is rotatably articulated on a first pivot point fixed to the housing, and a second decoupling device, which has a second spring device and a second lever device, by means of which the second side handle is rotatably articulated on a second pivot point fixed to the housing, is provided for decoupling the side handles from the housing, wherein the first spring device is fixed to the housing on one side, and is connected to the first lever device on the other side, and the second spring device is fixed to the housing on one side and connected to the second lever device on the other side. The spring devices are designed in particular as tension springs, and reduce vibrations acting on the side handles during operation of the machine tool.

Further advantages can be found in the following description of the figures. Different exemplary embodiments of the present invention are shown in the figures. The figures, the description, and the claims contain numerous features in combination. A person skilled in the art will expediently also consider the features individually and combine them to form meaningful further combinations.

### BRIEF DESCRIPTION OF THE DRAWINGS

In the drawings:

FIG. 1 shows a side view of a machine tool designed as a chipping hammer, with a chisel arranged in a tool holder; the machine tool is shown in an unloaded resting state;

FIG. 2 shows a three-dimensional view of the chipping hammer according to FIG. 1;

FIG. 3 shows a side view corresponding to FIG. 1 of the chipping hammer according to FIG. 1 and FIG. 2, wherein the chipping hammer is shown without a housing part;

FIG. 4 shows a side view of the chipping hammer according to FIG. 1 to FIG. 3 rotated by 90° compared to the illustration in FIG. 1; and

FIG. 5 shows a side view of the chipping hammer according to FIG. 1 to FIG. 4 arranged on a flat ground surface, wherein a protective device can be seen in a sectional view.

### DETAILED DESCRIPTION

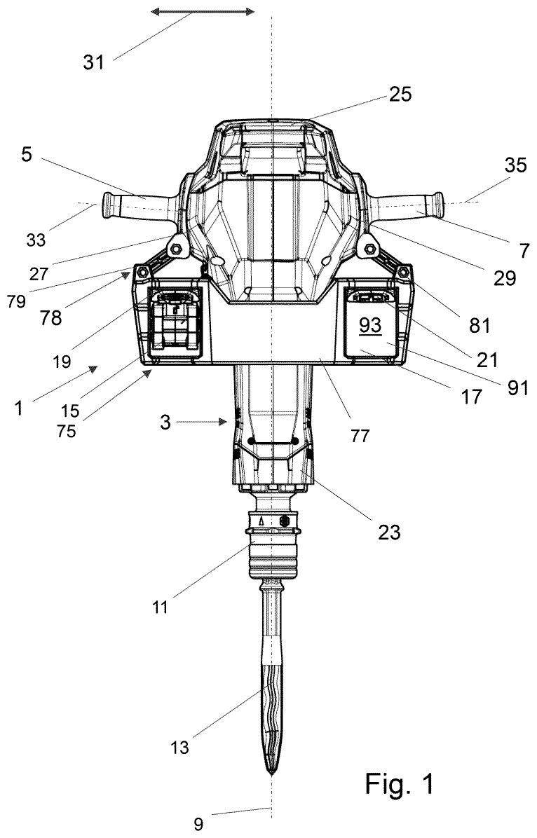

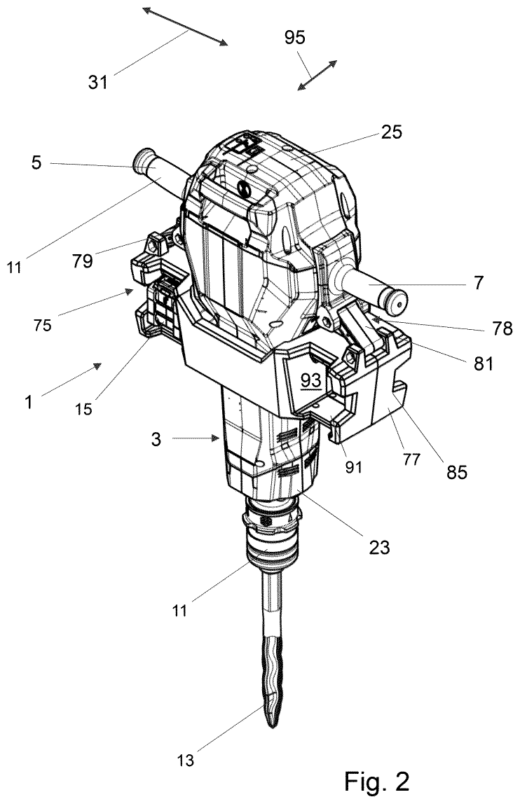

FIG. 1 to FIG. 5 each show a machine tool 1 designed as a chipping hammer. However, it is also possible for the machine tool 1 to be designed in the form of a screwdriver, a drill, a hammer drill or the like.

The machine tool 1 designed as a chipping hammer is shown in the drawings in a rest position, i.e., a non-actuated state, and has a housing 3 which can be designed in one piece or in multiple pieces. Furthermore, the machine tool 1 has a first side handle 5 and a second side handle 7, which are substantially symmetrical about a working axis 9 which defines a longitudinal axis or longitudinal direction of the machine tool 1. In the present case, a tool holder 11 is in engagement with a tool 13 designed as a chisel, which is located in the working axis 9.

An electric motor and an impact apparatus are contained in the interior of the housing 3. The impact apparatus can also be referred to as striking mechanism or striking apparatus. The electric motor and the impact apparatus are connected to one another in such a way that pulse-like strikes are generated and transmitted to the tool holder 11.

In order to supply the machine tool 1 and in particular the electric motor with electrical energy, a first rechargeable battery 15 and a second rechargeable battery 17 are provided in the present case, wherein the first rechargeable battery 15 is operatively connected to a first rechargeable battery interface device 19 and the second rechargeable battery 17 is operatively connected to a second rechargeable battery interface device 21. The battery interface devices 19, 21 are arranged on a protective device 75, which will be discussed in more detail below.

According to an alternative embodiment, it is also possible for only one rechargeable battery, or more than two rechargeable batteries, to be used.

The housing 3 has a lower end 23 in the longitudinal direction 9, in the region of which the tool holder 11 is provided, and an opposite upper end 25. Furthermore, the housing 3 has a first lateral region 27 and a second lateral region 29. The lateral regions 27, 29 form opposite boundaries of the housing 3 in the transverse direction 31. The transverse direction 31 is perpendicular to the working axis 9 and in the present case is substantially identical to the primary directions of extension 33, 35 of the side handles 5, 7 in the resting state of the machine tool 1.

The first side handle 5 is arranged in the first lateral region 27 and the second side handle 7 is arranged in the second lateral region 29 of the housing 3 opposite the first lateral region 27 in the transverse direction 31.

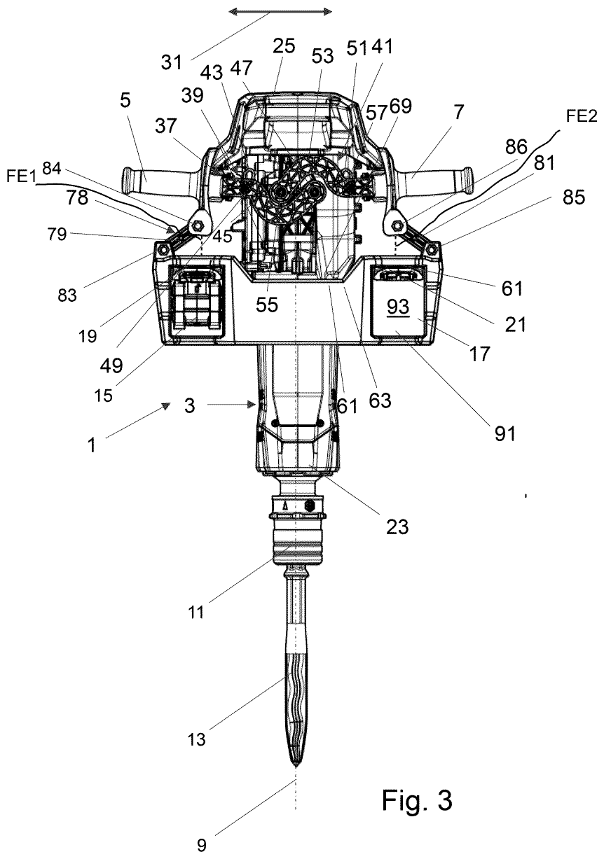

A decoupling apparatus 37, which can be seen in more detail in FIG. 3 as decoupling apparatus 37, is provided, by means of which the side handles 5 and 7 are decoupled to a certain extent from the housing 3 and thus from shocks, vibrations and the like that are transmitted to the housing 3 via the chisel 13 during operation of the machine tool 1.

In the present case, the decoupling apparatus 37 has a first decoupling device 39 assigned to the first side handle 5 and a second decoupling device 41 assigned to the second side handle 7 (see FIG. 3). The first decoupling device 39 has a first spring device designed as a tension spring 43, and a first lever device 45. The first lever device 45 is fixed to the housing with articulation on a first pivot point 47 on one side, and is connected on the other side to the first side handle 5. The first tension spring 43 is fixed to the housing on one side, and is linked on the other side to a first articulation point 49, which lies between the first pivot point 47 fixed to the housing and the first side handle 5. The first side handle 5 is thus displaceable relative to the housing 3 in a circular arc movement about the first pivot point 47 fixed to the housing, such that the first primary direction of extension 33 is rotatable relative to the transverse direction 31 through a certain angular range.

Similarly, the second decoupling device 41 has a second spring device, designed as a tension spring 51, and a second lever device 53. The second lever device 53 is fixed to the housing with articulation on a second pivot point 55 on one side, and is connected on the other side to the second side handle 7. The second tension spring 51 is fixed to the housing on one side, and is linked at the other end to a second articulation point 57, which is situated between the first pivot point 47 fixed to the housing and the first side handle 5. The second side handle 7 is thus displaceable relative to the housing 3 in a circular arc movement about the second pivot point 55 fixed to the housing, such that the second primary direction of extension 35 is rotatable relative to the transverse direction 31 through a certain angular range.

Provision can be made for each decoupling device 39, 41 to be assigned two tension springs 43, 51, such that two tension springs 43 work together with the first lever device 45 and two tension springs 51 work together with the second lever device 53.

The first pivot point 47 fixed to the housing is arranged between the second pivot point 55 fixed to the housing and the second side handle 7, with respect to the transverse direction 31. Accordingly, the second pivot point 55 fixed to the housing is arranged in the transverse direction 31 between the first pivot point 47 fixed to the housing and the first side handle 5. In this case, the lever devices 45 and 53 are designed to be curved in an opposite manner, in such a way that they enable simultaneous movement of the first side handle 5 and the second side handle 7 in the direction of the working axis downwards and upwards by a rotational movement about the respective pivot points 47, 55 fixed to the housing.

In the embodiment shown, the protective device 75 (see FIG. 1) is arranged on a side of the side handles 5, 7 facing the tool holder 11, and has a housing 77 which encloses or surrounds the circumference of the housing 3 of the machine tool 1. The protective device 75 is substantially symmetrical with respect to a central longitudinal plane of the machine tool 1.

In the present case, the protective device 75 is connected to the side handles 5, 7 via a connecting device 78. The connecting device 78 comprises a first lever 79 by means of which the protective device 75 is connected to the first side handle 5, and a second lever 81 by means of which the protective device 75 is connected to the second side handle 9. The first lever 79 has a first articulation point 83 in a region of the first side handle 5 close to the housing, and a second articulation point 84 in an outer region of the protective device 75 in the transverse direction 31. The second lever 81 has a third articulation point 85 in a region of the second side handle 7 close to the housing, and a fourth articulation point 86 in an outer region of the protective device 75 in the transverse direction 31. The second articulation point 84 and the fourth articulation point 86 are thus arranged in the transverse direction 31 in regions of the protective device 75 which are far from each other.

The protective device 75 is movable together with the side handles 5, 7, via the linkage to the side handles 5, 7 by means of the levers 79 and 81, relative to the housing 3 of the machine tool 1 during operation of the machine tool 1, wherein the protective device 75 can be displaced in the longitudinal direction 9 relative to the housing 3 of the machine tool 1 by means of the interaction of the decoupling apparatus 37 with the levers 79, 81 during operation of the machine tool 1. Alternately, as discussed above the connecting device 78 could be two flexible elements FE1 and FE2 of elastomeric material, shown solely schematically as alternative in FIG. 3.

In the rest position of the machine tool 1 shown in the figures, a small spacing is present between the housing 77 of the protective device 75 and the housing 3 of the machine tool 1 transverse to the working axis 9, to prevent the protective device 75 jamming against the housing 3 during operation of the machine tool 1.

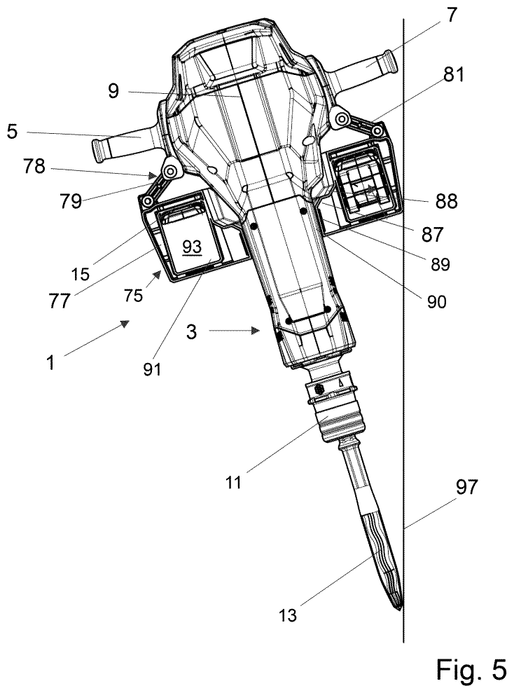

In order to ensure good protection of the rechargeable batteries 15, 17 connected to the battery interface devices 19, 21 during operation of the machine tool 1, and in particular also in the event that the machine tool 1 is dropped or falls, the housing 77 of the protective device 75 has a first stop region 87 and the housing 3 has a second stop region 88 provided for interacting with the first stop region 87 (see, e.g., FIG. 5). The first stop region 87 and the second stop region 88 have a defined distance from one another in the rest position of the machine tool 1 in the longitudinal direction 9. If the protective device 75 is displaced in the operation of the machine tool 1 or in particular in the event that the machine tool 1 is dropped or falls in a direction facing away from the tool holder 11 with respect to the longitudinal direction 9, the housing 77 of the protective device 75 comes into contact with the second stop region 88 of the housing 3 via the first stop region 87 after overcoming the spacing. As a result, an additional support of the protective device 75 on the housing 3, and thus also improved protection of rechargeable batteries 15, 17 connected to the battery interface devices 19, 21, is achieved.

Furthermore, the protective device 75 in the present case has a third, preferably completely circumferential stop region 89. The housing 3 has a fourth stop region 90 which is provided for interacting with the third stop region 89 of the protective device 75. For example, in the event that the machine tool 1 is dropped or falls, a part of the third circumferential stop region 89 of the protective device 75 comes into contact with a part of the fourth stop region 90 of the housing 3. Preferably, the protective device 75 rests on the housing 3 via a continuous region in the longitudinal direction 9, such that a good support action is achieved, and rechargeable batteries 15, 17 connected to the battery interface devices 19, 21 are particularly well protected.

The first battery interface device 19 is arranged here in a region of the protective device 75 assigned to the first side handle 5—i.e., on the side of the machine tool 1 that is the same as that of the first side handle 5 with respect to the transverse direction 31. Similarly, the second battery interface device 21 is arranged in a region of the protective device 75 assigned to the second side handle 7, i.e., on the side of the machine tool 1 that is the same as that of the second side handle 7 with respect to the transverse direction 31, and on a side of the machine tool 1 opposite the side of the first side handle 5.

The first battery interface device 19 is designed to be substantially mirror-symmetric to the second battery interface device 21 with respect to the working axis 9, wherein the first battery interface device 19 is described in the following so as to be representative for the second battery interface device 21 as well.

The first battery interface device 19 has a substantially planar base plate 61 and a connecting device 63 for receiving the first rechargeable battery 15, wherein the first rechargeable battery 15 comes into operative connection with the connecting device 63 via a movement in the insertion direction 65, and can be released from the connecting device 63 in a direction of movement oriented in the opposite direction (see, e.g., FIG. 3). By means of the connecting device 63, the second rechargeable battery 17 can be detachably connected to the protective device 75 and thus to the machine tool 1 both mechanically and electrically. As a result of the releasable connection of the first rechargeable battery 15, electrical energy can pass from the rechargeable batteries 15, 17 to the consumers, for example the electric motor, of the machine tool 1. It is possible for only a single rechargeable battery to be used to supply the machine tool 1.

In the present case, the insertion direction 65 is oriented perpendicular to the longitudinal direction 9 and to the transverse direction 31 in a frontal direction 95, but can in principle be oriented as desired in alternative embodiments, and can extend, for example, in the transverse direction 31. Furthermore, the insertion direction 65 can have an angle relative to the frontal direction 95, the transverse direction 31, and/or the longitudinal direction 9.

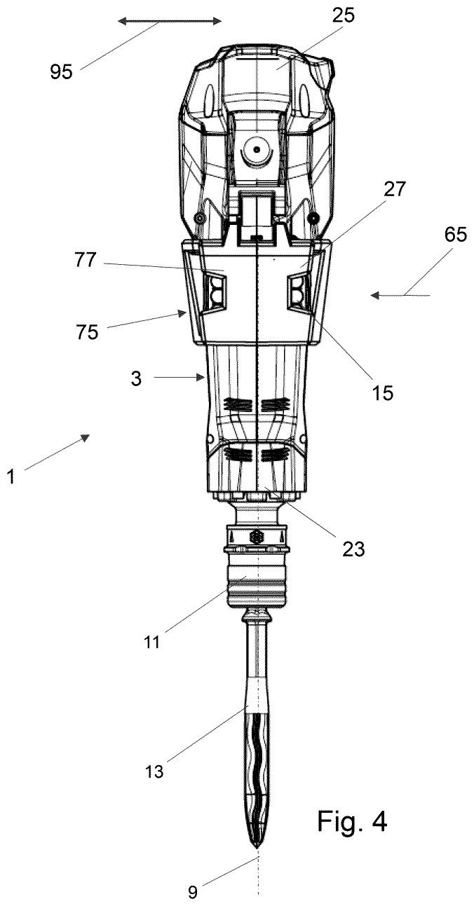

To accommodate the first rechargeable battery 15, the protective device 75 has a recess 91 which enables an arrangement of the first rechargeable battery 15 in the insertion direction 65 on the first battery interface device 19 (see, e.g., FIG. 4). In alternative embodiments, the recess can also be provided at other positions, such that an arrangement of the rechargeable battery on the first battery interface device is possible with essentially any conceivable insertion directions 65.

In an installed state of the first protective device 75, the protective device 75 forms a type of cage with an interior space 93. In the present case, the protective device 75 is designed such that the rechargeable battery 17 can be arranged completely in the interior space 93 defined by the protective device 75.

The protective device 75 can in principle be designed in one piece or in multiple parts. Provision can be made so that the rechargeable battery in the state connected to the battery interface device is not arranged completely in the interior, but at least partially projects out of the interior space.

In this case, however, the protective device 75 is preferably also designed in such a way that, in the event that the machine tool 1 is dropped or falls in essentially any given direction, the protective device 75 comes into contact with a flat ground surface 97 in essentially any given direction before a rechargeable battery 15 connected to the battery interface device 19, such that the rechargeable battery 15 is protected to the desired extent by the protective device 75 (see e.g., FIG. 5).

What is claimed is:

1-12. (canceled)

13. A machine tool having a working axis running in a longitudinal direction, the machine tool comprising:
a housing;
at least one rechargeable battery interface for detachably connecting at least one rechargeable battery to the machine tool; and
a first side handle having a first primary direction of extension and a second side handle having a second primary direction of extension, wherein the first and second side handles are arranged symmetrically about the longitudinal direction;
at least one decoupler to create a vibration-damping connection of the first and second side handles to the housing; and
a protector for protecting a rechargeable battery coupled to the at least one rechargeable battery interface, the protector has an interior space for at least partially accommodating the at least one rechargeable battery, the protector enclosing the circumference of the housing of the machine tool with respect to the longitudinal direction and being connected to at least one of the first and second side handles via at least one connector.

14. The machine tool as recited in claim 13 wherein the connector is designed in such a way that the protector is movable in the longitudinal direction relative to the housing.

15. The machine tool as recited in claim 13 wherein the connector has at first lever and a second lever levers, the protector being connected to the first side handle via the first lever and to the second side handle via the second lever.

16. The machine tool as recited in claim 13 wherein the protector is connected to the first side handle via a first flexible element and to the second side handle via a second flexible element.

17. The machine tool as recited in claim 16 wherein the first and second flexible elements are designed with an elastomeric material.

18. The machine tool as recited in claim 13 wherein the protector has a first stop region, and the housing has a second stop region, wherein the protector and the housing come into contact with one another via the first and second stop regions when the protective device is displaced relative to the housing by a value greater than a defined threshold value in the longitudinal direction starting from a rest position.

19. The machine tool as recited in claim 13 wherein the protector has a third stop region, and the housing has a fourth stop region, the third stop region and the fourth stop region extending in the longitudinal direction.

20. The machine tool as recited in claim 13 wherein the protector is arranged on a side of the first or second side handle facing a tool holder with respect to the longitudinal direction.

21. The machine tool as recited in claim 13 wherein the at least one rechargeable battery interface includes two rechargeable battery interfaces in the protector, the two rechargeable battery interface devices being arranged about the longitudinal axis.

22. The machine tool as recited in claim 21 wherein the two rechargeable battery interface devices are arranged symmetrically arranged about the longitudinal axis.

23. The machine tool as recited in claim 13 wherein the protector has at least one recess for the operative connection of a rechargeable battery to the at least one rechargeable battery interface, the recess facing perpendicular to the longitudinal direction and perpendicular to a transverse direction.

24. The machine tool as recited in claim 13 wherein the protector is designed in such a manner that, when a rechargeable battery is connected to at least one rechargeable battery interface, and the machine tool is dropped in any direction, the protector comes into contact with a flat ground surface before the rechargeable battery connected to the at least one rechargeable battery interface.

25. The machine tool as recited in claim 13 wherein the at least one decoupler includes a first decoupler having a first spring and a first lever, the first side handle being rotatably articulated on a first pivot point fixed to the housing via the first lever, and a second decoupler having a second spring and a second lever, the second side handle being rotatably articulated on a second pivot point fixed to the housing via the second lever, the first spring being fixed to the housing on one side, and connected to the first lever on an other side, and the second spring being fixed to the housing on a second spring side, and is connected to the second lever device on another second spring side.

26. The machine tool as recited in claim 13 wherein the machine tool is a chipping hammer.
